(19) United States
(12) Patent Application Publication
(10) Pub. No.: US 2012/0228084 A1
(43) Pub. Date: Sep. 13, 2012

(54) Rolling Chip Conveyor

(76) Inventor: Yi-Hao Chung, Xiluo Township (TW)

(21) Appl. No.: 13/044,753

(22) Filed: Mar. 10, 2011

(51) Int. Cl. B65G 47/46; B65G 45/12

(52) U.S. Cl. 198/370.01

(57) ABSTRACT

A rolling chip conveyor contains a body including a lower segment, a tilted segment, and an upper segment, two ends of the tilted segment connecting with the lower segment and the upper segment respectively, the upper segment including a first outlet to eliminate rough chips outside, a second outlet to eliminate fine chips, and a driving device, the second outlet being fixed on the body and facing downward, the first outlet being disposed on one side of the upper segment; a tracking belt arranged in the body to correspond to the lower segment, the tilted segment, and the upper segment, engaging with and being actuated by the driving device, the tracking belt including al least one hole; a scraper disposed proximate to the second outlet and contacting with the tracking belt; a first filter corresponding to the first outlet and beings fixed around an inner side of the tracking belt.

### BACKGROUND OF THE INVENTION

1. Field of the Invention

The present invention relates to a chip conveyor, and more particularly to a rolling chip conveyor.

2. Description of the Prior Art

A conventional chip conveyor contains a body including a tilted surface formed thereon at a proper angle, an outlet to eliminate chip extending outward from the tilted surface, a transmitting mechanism fixed above the outlet to actuate a tracking belt, and a removing plate secured on the tracking belt to eliminate rough chips on a bottom end of the body, the rough chips are further conveyed toward the outlet from the tilted surface.

However, such a conventional chip conveyor have to eliminate chips by using the removing plate and a scraping piece additionally, thus eliminating chips at a high cost and consuming time.

The present invention has arisen to mitigate and/or obviate the afore-described disadvantages.

### SUMMARY OF THE INVENTION

The primary object of the present invention is to provide a rolling chip conveyor that is capable of being used to drive a single tracking belt, operated and maintained easily

Another object of the present invention is to provide a rolling chip conveyor that is used to scrape the rough and the fine chips, and produced at a lower cost.

To obtain the above objective, a rolling chip conveyor provided by the present invention contains:

a body including a lower segment, a tilted segment, and an upper segment, two ends of the tilted segment connecting with the lower segment and the upper segment respectively, and the upper segment including a first outlet to eliminate rough chips outside, a second outlet to eliminate fine chips, and a driving device, the second outlet being fixed on the body and facing downward, and the first outlet being disposed on one side of the upper segment;

a tracking belt arranged in the body to correspond to the lower segment, the tilted segment, and the upper segment, engaging with and being actuated by the driving device, the tracking belt including al least one hole secured therein;

a scraper disposed proximate to the second outlet and contacting with the tracking belt;

a first filter corresponding to the first outlet and beings fixed around an inner side of the tracking belt.

### BRIEF DESCRIPTION OF THE DRAWINGS

FIG. 1 is a perspective view showing the assembly of a chip conveyor according to a preferred embodiment of the present invention;

FIG. 2 is an amplified plan view of a tracking belt of the chip conveyor according to the preferred embodiment of the present invention;

FIG. 3 is a plan view showing the assembly of the chip conveyor according to the preferred embodiment of the present invention;

FIG. 4 is an amplified plan view showing a part of an upper segment of a body of the chip conveyor according to the preferred embodiment of the present invention;

FIG. 5 is a partial perspective view showing a scraper contacting with the tracking belt according to the preferred embodiment of the present invention;

FIG. 6 is a partial perspective view of a second roller of the chip conveyor according to the preferred embodiment of the present invention;

FIG. 7 is a partial perspective view of a driving device of the chip conveyor according to the preferred embodiment of the present invention;

FIG. 7A is an enlarged view of a tracking belt of a driving device of the chip conveyor according to the preferred embodiment of the present invention;

FIG. 8 is a partial plan view showing a screw rod being inserted through a first filter horizontally according to the preferred embodiment of the present invention;

FIG. 9 is a partial plan view showing the screw rod being inserted through the first filter horizontally and contacting with a motor according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

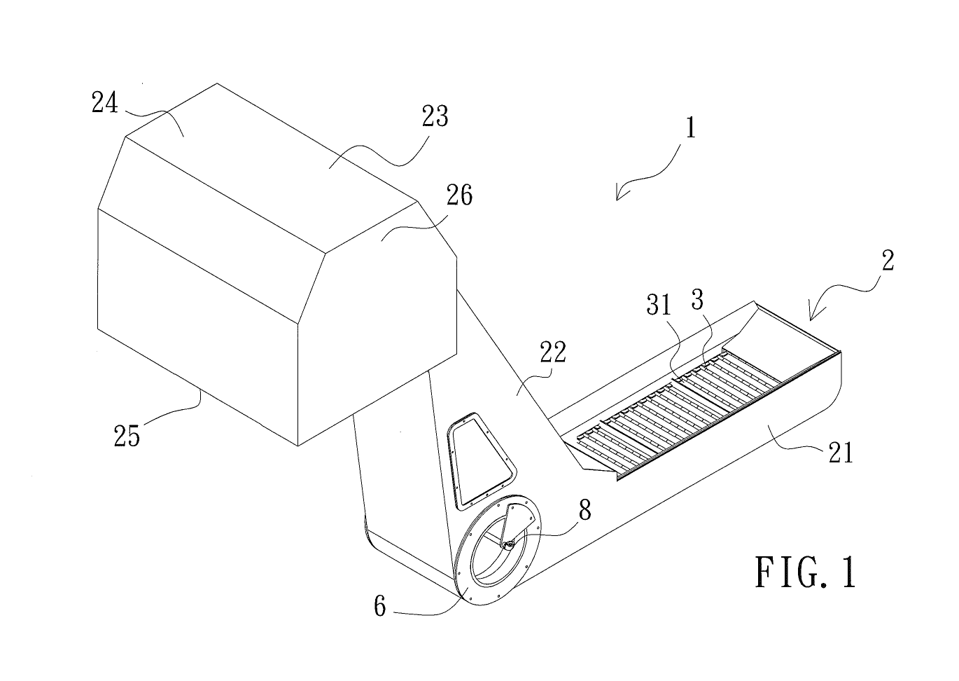

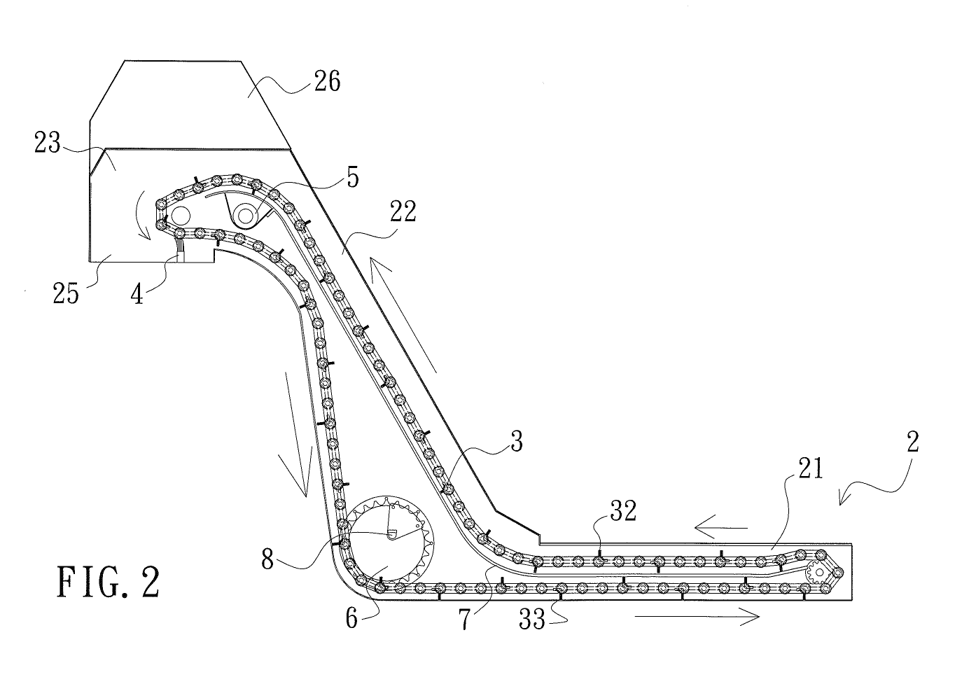

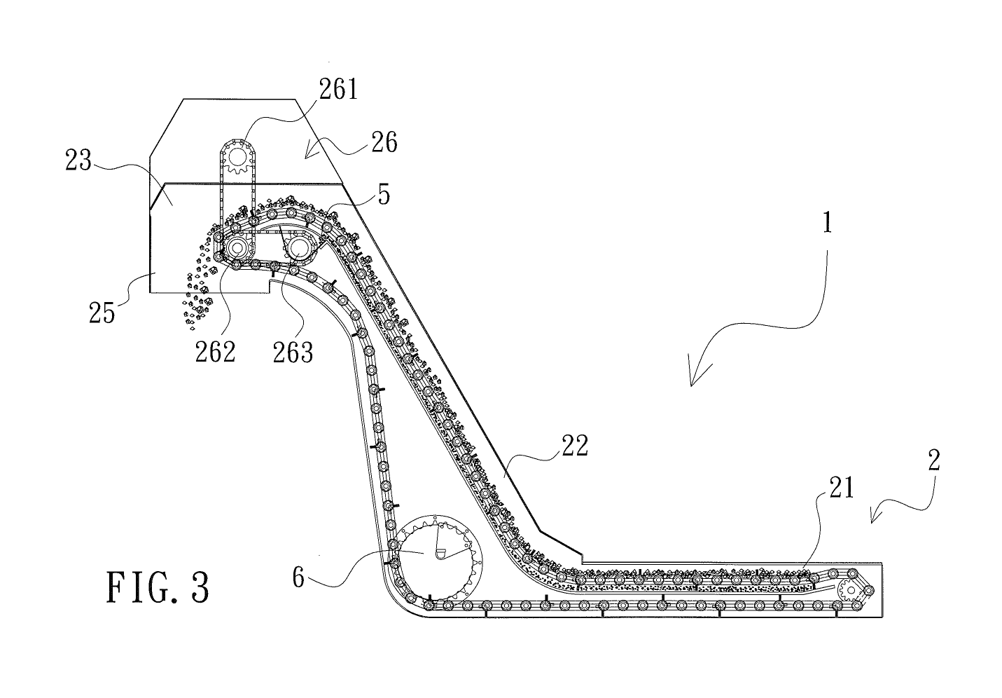

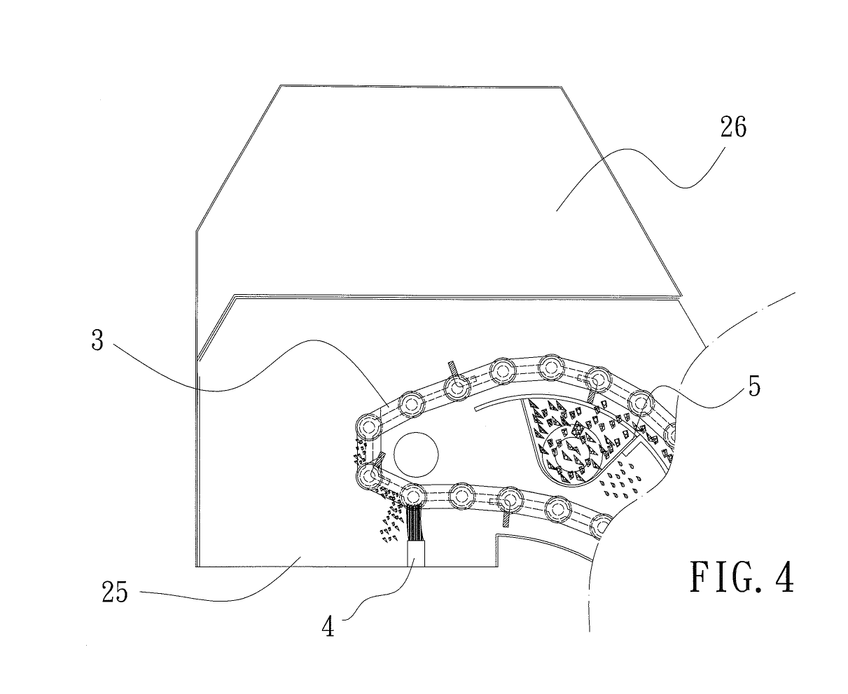

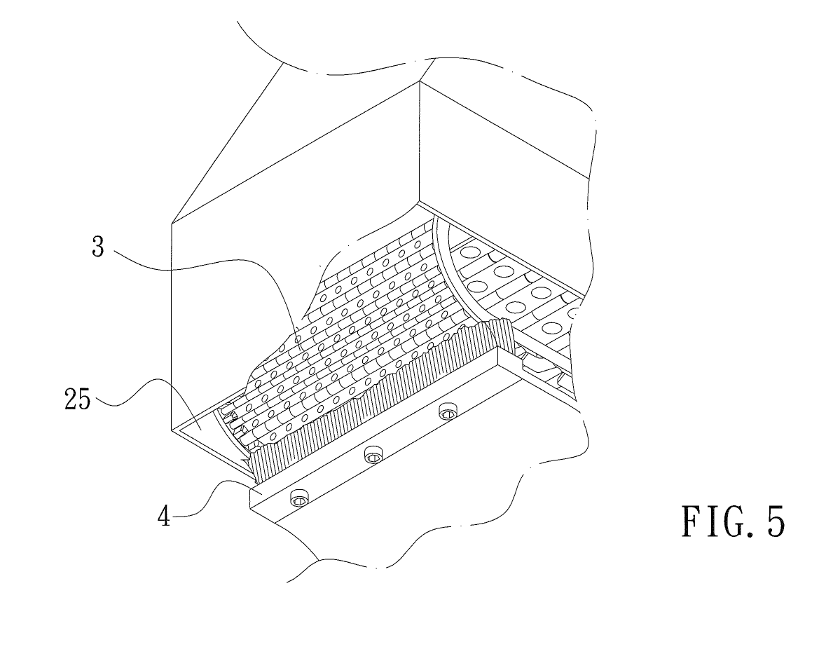

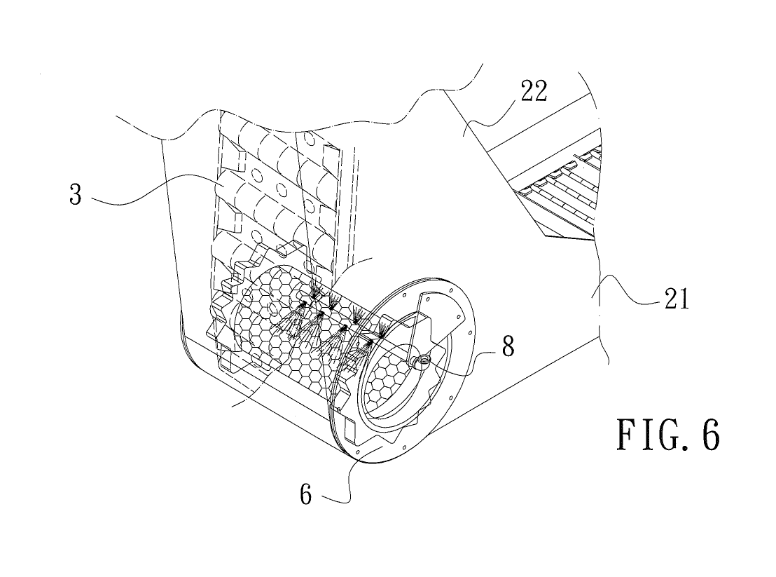

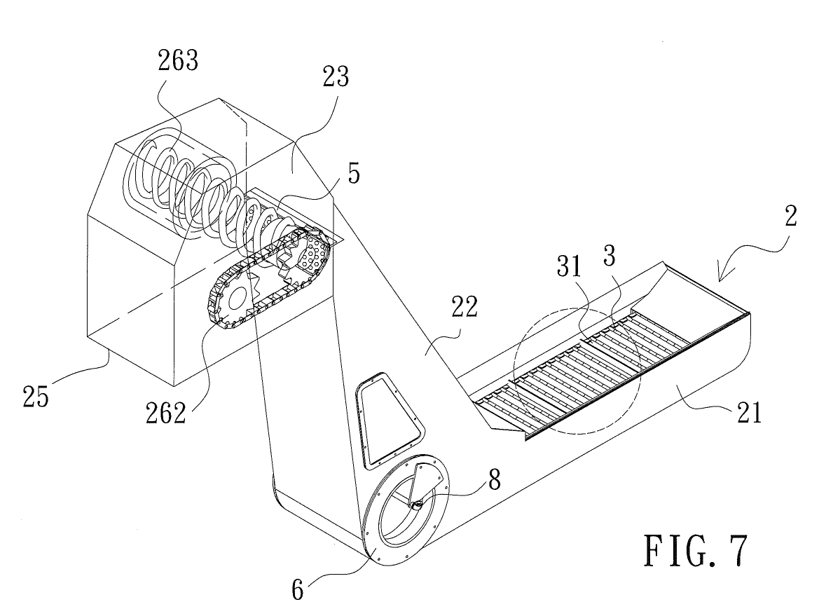

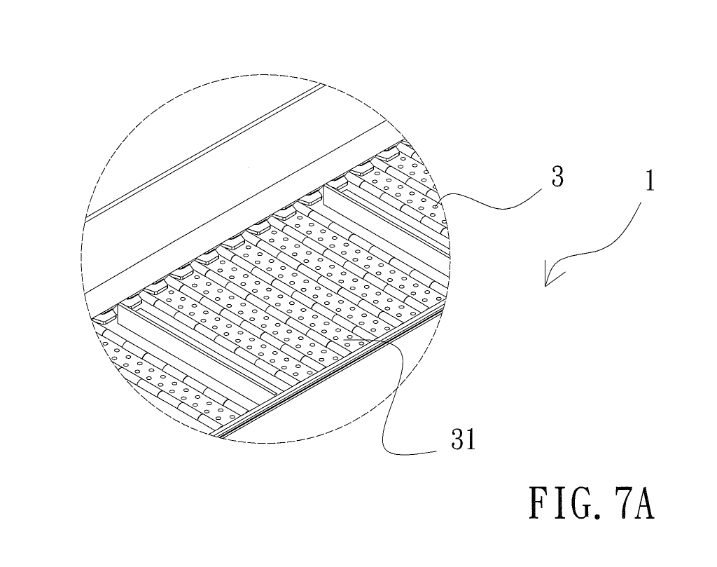

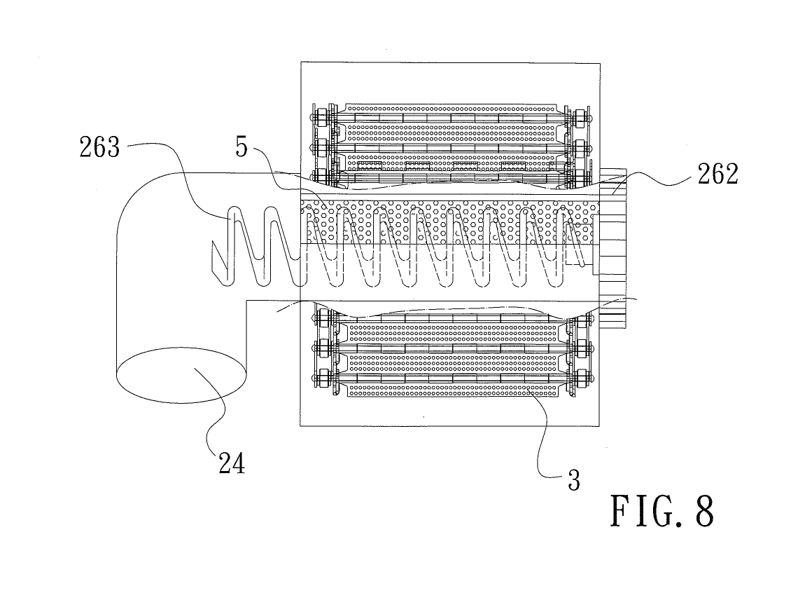

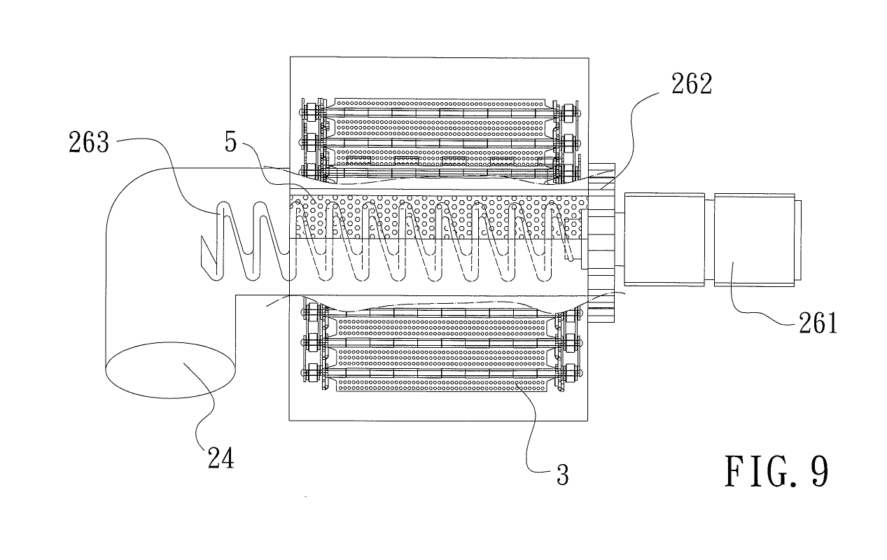

With reference to FIGS. 1-9, a rolling chip conveyor 1 according to a preferred embodiment of the present invention comprises a body 2, a tracking belt 3, a scraper 4, a first filter 5, and a second roller 6.

The body 2 includes a lower segment 21, a tilted segment 22, and an upper segment 23, wherein two ends of the tilted segment 22 connect with the lower segment 21 and the upper segment 23 respectively, and the upper segment 23 includes a first outlet 24 to eliminate rough chips outside, a second outlet 25 to eliminate fine chips, and a driving device 26; the second outlet 25 is fixed on the body 2 and faces downward, and the first outlet 24 is disposed on one side of the upper segment 23.

The driving device 26 includes a motor 261, a drive spindle 262, and a screw rod 263, wherein the drive spindle 262 engages with the tracking belt 3, and the screw rod 263 is inserted through the first filter 5 horizontally, the motor 261 is used to drive the drive spindle 262 to rotate, and the drive spindle 262 is served to actuate the screw rod 263 to rotate.

The tracking belt 3 is arranged in the body 2 to correspond to the lower segment 21, the tilted segment 22, and the upper segment 23, engages with the drive spindle 262 of the driving device 26, and is actuated by the drive spindle 262, the tracking belt 3 includes at least one hole 31 secured therein.

The tracking belt 3 also includes a plurality of first scraping plates 32 and second scraping plates 33 fixed on an upper surface and a lower surface thereof individually, and vertical sections of the first and the second scraping plates 32, 33 are crossed with each other.

The tracking belt 3 further includes an insulating panel 7 secured therein and couples with the first filter 5, and the insulating panel 7 connects with the first filter 5 along the tracking belt 3 from the lower segment 21 via the tilted segment 22, and a distance between the insulating panel 7 and the tracking belt 3 is larger than a length of the second scraping plate 33.

The scraper 4 is disposed proximate to the second outlet 25 and contacts with the tracking belt 3 so that when the tracking belt 3 is transmitted, the fine chips attached on the tracking belt 3 are scraped off by using the scraper 4 and fall in the second outlet 25.

The first filter 5 corresponds to the first outlet 24 and is fixed around an inner side of the tracking belt 3, when the tracking belt 3 is transmitted toward the upper segment 23 from the tilted segment 22, the fine chips fall on the insulating panel 7 via the holes 31 of the tracking belt 3 and are conveyed toward the tilted segment 22 and the upper segment 23 from the lower segment 21 by ways of the tracking belt 3, thereafter the fine chips on the insulating panel 7 are scraped onto the first filter 5 by means of the second scraping plates 33 and guided into the first outlet 24 by using the screw rod 263.

The second roller 6 is secured on a connection of the tilted segment 22 and the lower segment 21 and engages with the inner side of the tracking belt 3, such that when the tracking belt 3 is transmitted, the tilted segment 22 moves from the lower segment 21 to the upper segment 23 or from the upper segment 23 to the lower segment 21, and a part of the fine chips and/or the rough chips fall on an inner side of the tracking belt 3 which turns around, and the second roller 6 is provided to eliminate the falling fine or rough chips.

The second roller 6 includes a cleaning device 8 to wash the tracking belt 3 when the tracking belt 3 rotates toward the upper segment 23 from the lower segment 21 via the tilted segment 22, and water on the tracking belt 3 is collected and filtered when the tracking belt 3 rotates toward the first filter 5 from the lower segment 21 through the tilted segment 22; the cleaning device 8 is also capable of cleaning the rough chips on the tracking belt 3 and the fine chips on the insulating panel 7, and then the fine chips are carried toward the first filter 5 to collect and filter the water on the fine chips, thus obtaining cleaning effect.

Thereby, a single motor of the rolling chip conveyor is capable of being used to drive a single tracking belt. The rolling chip conveyor is operated and maintained easily, used to scrape the rough and the fine chips, and produced at a lower cost.

While we have shown and described various embodiments in accordance with the present invention, it is clear to those skilled in the art that further embodiments may be made without departing from the scope of the present invention.

What is claimed is:

1. A rolling chip conveyor comprising:
a body including a lower segment, a tilted segment, and an upper segment, two ends of the tilted segment connecting with the lower segment and the upper segment respectively, and the upper segment including a first outlet to eliminate rough chips outside, a second outlet to eliminate fine chips, and a driving device, the second outlet being fixed on the body and facing downward, and the first outlet being disposed on one side of the upper segment;
a tracking belt arranged in the body to correspond to the lower segment, the tilted segment, and the upper segment, engaging with and being actuated by the driving device, the tracking belt including al least one hole secured therein;
a scraper disposed proximate to the second outlet and contacting with the tracking belt;
a first filter corresponding to the first outlet and beings fixed around an inner side of the tracking belt.

2. The rolling chip conveyor as claimed in claim 1 further comprising a second roller secured on a connection of the tilted segment and the lower segment and engaging with the inner side of the tracking belt.

3. The rolling chip conveyor as claimed in claim 1, wherein the driving device includes a motor, a drive spindle, and a screw rod, the drive spindle engages with the tracking belt, and the screw rod is inserted into the first filter horizontally, the motor is used to drive the drive spindle to rotate, and the drive spindle is served to actuate the screw rod to rotate.

4. The rolling chip conveyor as claimed in claim 1, wherein the tracking belt includes a plurality of first scraping plates and second scraping plates fixed on an upper surface and a lower surface thereof individually, and vertical sections of the first and the second scraping plates are crossed with each other.

5. The rolling chip conveyor as claimed in claim 2, wherein the second roller includes a cleaning device.

6. The rolling chip conveyor as claimed in claim 1, wherein the insulating panel connects with the first filter and is fixed in the tracking belt to correspond to the tilted portion and the lower portion.
